(19) United States
(12) Patent Application Publication
(10) Pub. No.: US 2006/0123688 A1
(43) Pub. Date: Jun. 15, 2006

(54) BOBB,n head decoy

(76) Inventors: Joe G. Box, Twinsburg, OH (US); Glenn H. Lindaman, Whitehall, PA (US)

Correspondence Address: Gregory S. Vickers, Esq.;Fay, Sharpe, Fagan, Minnich & McKee, LLP, 1100 Superior Avenue, Seventh Floor, Cleveland, OH, 44114-2579, US

(21) Appl. No.: 11/267,997

(22) Filed: Nov. 7, 2005

Related U.S. Application Data
(60) Provisional application No. 60/626,419, filed on Nov. 9, 2004.

(51) Int. Cl. A01M 31/06

(52) U.S. Cl. 43/3

(57) ABSTRACT

A decoy comprising an outer body that resembles a creature of nature and an appendage that moves relative to the outer body. The outer body defining the outer limits of an inner cavity and including at least one opening. The appendage being joined to the decoy at an appendage joint spaced from the outer body and within the inner cavity, such that the appendage extends from the opening and moves relative to the outer body about a pivot point at least partially within the inner cavity.

This application claims priority in U.S. Provisional Patent Application No. 60/626,419 filed on Nov. 9, 2004.

### FIELD OF THE INVENTION

The invention of this application concerns improved bird hunting decoys, and more particularly, to a decoy structure that produces realistic body movement. A hunting decoy according to the present invention, for example, can be shaped and colored to represent a water fowl such as a duck. However, the invention of this application has much broader applications and should not be limited to a specific type of decoy and/or hunting decoy.

### INCORPORATION BY REFERENCE

The invention of this application relates to animal figurines that can be used as hunting decoys. Lindaman U.S. Pat. Nos. 6,216,382 and 6,481,147 disclose hunting decoys, including a hollow decoy structure and a support stake support structure, and are hereby incorporated by reference for showing the same. Samaras U.S. Pat. No. 6,092,322 discloses a decoy with moving body parts and is also incorporated by reference herein for showing the same. Sroka U.S. Pat. No. 5,570,531 describes a bird decoy with motion associated with the decoy's head and neck and is also incorporated by reference herein for showing the same.

### BACKGROUND OF THE INVENTION

Decoys are known in various shapes and colors to resemble specific animals, a familiar example being game birds. The decoys may be attractive to the corresponding species of game animal or to a different species, as a result of various instincts. These include, for example, social herding or similar safety-in-numbers instincts, predation or other expectation of finding food, opportunities for procreation, the urge to maintain territorial exclusivity, establishment of a place in a hierarchical pecking order, etc.

A decoy advantageously resembles a particular species accurately, at least as to attributes that a target species is inclined to notice. The decoy may be quite realistic, or may simply have critical attributes in common with the particular species it emulates, such as a comparable silhouette, color, movement, sound, odor, etc.

Decoys that appear realistic to humans are more popular among hunters than those that are obviously artificial. The target species may be prone to respond, positively or negatively, to the same aspects as humans, or possibly other aspects. Visually, many animals are highly sensitive to motion.

Visual mimicry is an important consideration, but not the only one. Decoys should be inexpensive to manufacture. The decoy should be compact or subject to packing in a manner that permits a hunter to carry a number of decoys into the field. The decoys should individually be very easy to deploy, quickly and silently, in any terrain that may be encountered, such as open grassland, woods or scrub vegetation.

U.S. Pat. No. 5,570,531 describes a bird decoy with motion associated with the head and neck. The decoy body is stationary. A one-piece head-and-neck portion is mounted to the body so that the head and neck may tilt when sufficient wind prevails. The decoy is helpful in that it moves, but it is not representative of a live animal, since the pivot point of the decoy is unnatural. This produces the appearance of displacement of an integrally rigid head and neck relative to the body. Further, the range of motion is limited based on the pivot point of the head and neck assembly, which makes the decoy of the '531 patent appear unnatural. Further, the pivot point of the movement creates a condition where the head and neck assembly creates greater friction and, therefore, produces less movement in response to wind or other natural forces.

A game animal is sensitive to motion and expects to see realistic motion in live animals. Suspicious, unrealistic motion detracts from the effectiveness of the decoy. A group of decoy bodies that spin on their axes in a relatively uncontrolled and mechanical way, facing in random directions at any given time, and possibly spinning through more than 180 or even 360 degrees is suspicious, even if the static shape and color of the decoys is highly realistic. Further, decoys with unnatural head motion will be less effective in operation. The motion of the head needs to be as representative as possible to the natural head and neck motion of the particular game animal to be effective.

### SUMMARY OF THE INVENTION

The present invention is applicable generally to visual decoys that are intended to approximate the appearance of a particular species, and preferably to exhibit realistic forms of motion. The decoys may represent any species and/or gender to which animals instinctively respond. With respect to this application, the discussion will be limited to water fowl and, in particular, ducks. However, this application has much a broader application and can be practiced in connection with a wide range of decoys and/or hunting decoys. For example, the invention can be applied to decoys representing animals that frequent dry land or water, mammals or birds, prey animals or predators, etc. Further, the invention of this application can be used in connection with predator animals to prevent damage from unwanted wildlife or any other use associated with simulating wildlife.

In accordance with the present invention, a decoy is provided which advantageously produces lifelike motion by including an appendage that is joined to the decoy body at a point below the outer body surface such that the appendage, such as a head and neck assembly, can move relative to the decoy body at a pivot point at least partially below the outer body surface.

In accordance with another aspect of the present invention, provided is an appendage mounting structure that can be used in connection with a general upwardly extending body cavity for use with both spring and non-spring head actuating mechanisms.

In accordance with a further aspect of the present invention, provided is a damping mechanism that can be used to help restrict the movement of the decoy body and the decoy head. The damping device can be, for example, a rubber or polymer sleeve coaxial to and covering the spring mechanisms. In another embodiment, the damping or homing of the moving parts relative to the other components can be achieved by the shaped relationship between the moving parts such as by detents in one or more of the components of the movement joints or even the shape of the cavity opening.

In accordance with even yet another aspect of the present invention, the decoy of the present invention can be designed to be used on both land and water.

These and other aspects of the invention will be apparent to those skilled in the art in view of the following discussion on embodiments of this application.

### BRIEF DESCRIPTION OF THE DRAWINGS

The foregoing will in part be obvious and in part be pointed out more fully hereinafter in connection with a written description of preferred embodiments of the present invention illustrated in the accompanying drawings in which:

FIG. 1 is a longitudinal sectional view of a decoy assembly according to one aspect of the present invention;

FIG. 2 is a longitudinal sectional view of a decoy assembly of another embodiment of the present invention;

FIG. 3 is a longitudinal sectional view of a decoy assembly of yet another embodiment of the present invention;

FIG. 4 is an enlarged longitudinal sectional view of a head cavity shown in FIG. 3 with the weight in a first position;

FIG. 5 is an enlarged longitudinal sectional view of the head cavity shown in FIG. 3 with the weight in a second position;

FIG. 6 is a longitudinal sectional view of a decoy assembly of yet a further embodiment of the present invention;

FIG. 7 is a longitudinal sectional view of a decoy assembly of another embodiment of the present invention;

FIG. 8 is a longitudinal sectional view of a decoy assembly of a further embodiment of the present invention;

FIG. 9 is a longitudinal sectional view of a decoy assembly of even yet a further embodiment of the present invention;

FIG. 10 is a longitudinal sectional view of a decoy assembly of yet another embodiment of the present invention;

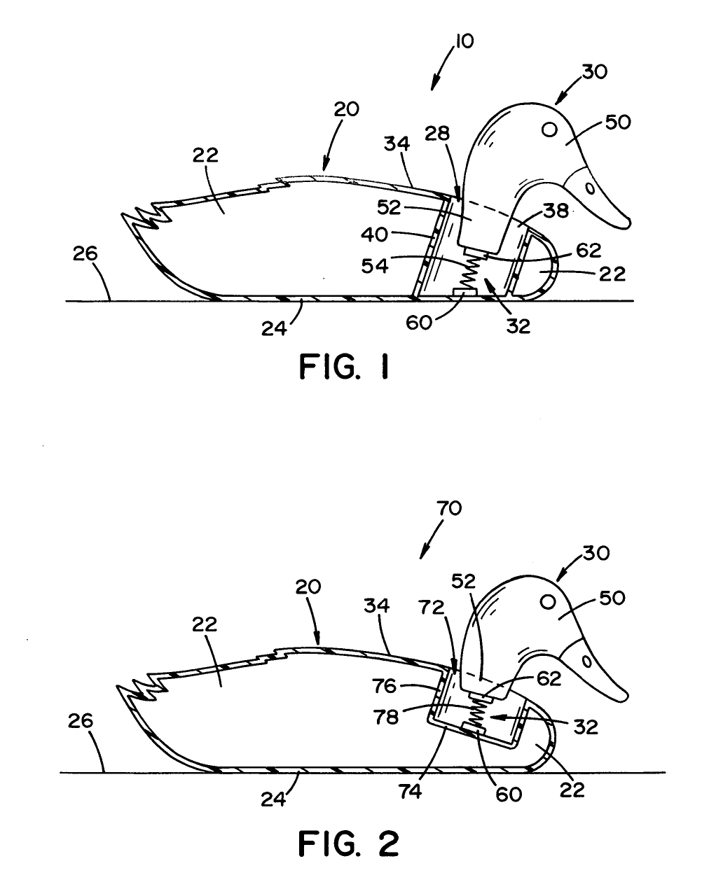

FIG. 1 is a longitudinal sectional view of a decoy assembly of even yet another embodiment of the present invention;

FIG. 12 is a longitudinal sectional view of a decoy assembly of a further embodiment of the present invention;

FIG. 13 is a longitudinal sectional view of a decoy assembly of another embodiment of the present invention;

FIG. 14 is a longitudinal sectional view of a decoy assembly of yet another embodiment of the present invention;

FIG. 15 is a longitudinal sectional view of a decoy assembly of yet another embodiment of the present invention;

FIG. 16 is an enlarged sectional view taken along lines 16-16 of FIG. 14;

FIG. 17 is a longitudinal sectional view of a decoy assembly of a further embodiment of the present invention;

FIG. 18 is a longitudinal sectional view of a decoy assembly of yet a further embodiment of the present invention;

FIG. 19 is an enlarged sectional view taken along lines 19-19 of FIG. 17;

FIG. 20 is an enlarged sectional view taken along lines 20-20 of FIG. 18;

FIG. 21 is an enlarged sectional view taken along lines 21-21 of FIG. 20; and,

FIG. 22 is a perspective view of an outer decoy body showing the head cavity.

### DETAILED DESCRIPTION OF THE PREFERRED EMBODIMENTS

Referring now in greater detail to the drawings wherein the showings are for the purpose of illustrating preferred embodiments of the invention only, and not for the purpose of limiting the invention, FIG. 1 illustrates a decoy 10 assembly according to one aspect of the invention, specifically a duck decoy, shown in cross section through a medial plane. FIG. 22 shows a front perspective view of body 20. The assembly generally comprises a decoy body 20 and a head assembly 30 joined to body 20 by a pivoting assembly 32. More particularly, body 20, which can be made by any manufacturing technique known in the art including, but not limited to, blow molding, is a closed chamber body having a large closed chamber 22 that can include a flat bottom 24 which allows decoy 10 to be placed on the ground and/or, which will be discussed in greater detail below, on water.

Body 20 includes a head cavity 28 that can extend between bottom 24 and a top body surface 34 which has an upper opening 38. In this embodiment, cavity 28 is a closed, cupped shaped cavity with a side wall 40 extending between bottom 24 and opening 38. While the bottom of cavity 28 is shown to be a portion of bottom 24 of body 20, cavity 28 can include a separate bottom that is adjacent and/or spaced from bottom 24.

Head assembly 30 includes a head 50 and a neck 52, and the assembly is pivotably joined to body 20 by pivoting assembly 32. In this respect, assembly 32 includes a flexible member 54 extending between a base joint 60 on bottom 24 and a head joint 62 on head assembly 30. Since base joint 60 is at or near bottom 24, the point of pivotable motion of head assembly 30 is near bottom 24, which produces a more realistic head motion. While not shown, the motion of the head assembly can be restricted by the size and/or shape of opening 38 which can be configured differently than walls 40. As can be appreciated, motion of head assembly 30, if excessive, can appear unnatural and can cause increased wear to the pivoting assembly and/or other components of decoy 10.

While not fully shown, body 20 and head assembly 30 can be configured and/or colored any way known in the art to produce a desired look without detracting from the invention of this application.

In the following discussions concerning other embodiments of this application, reference to similar components as discussed above will include the same reference numbers as described above. However, as can be appreciated, use of like reference numbers does not mean that the particular component must be identical in all respects.

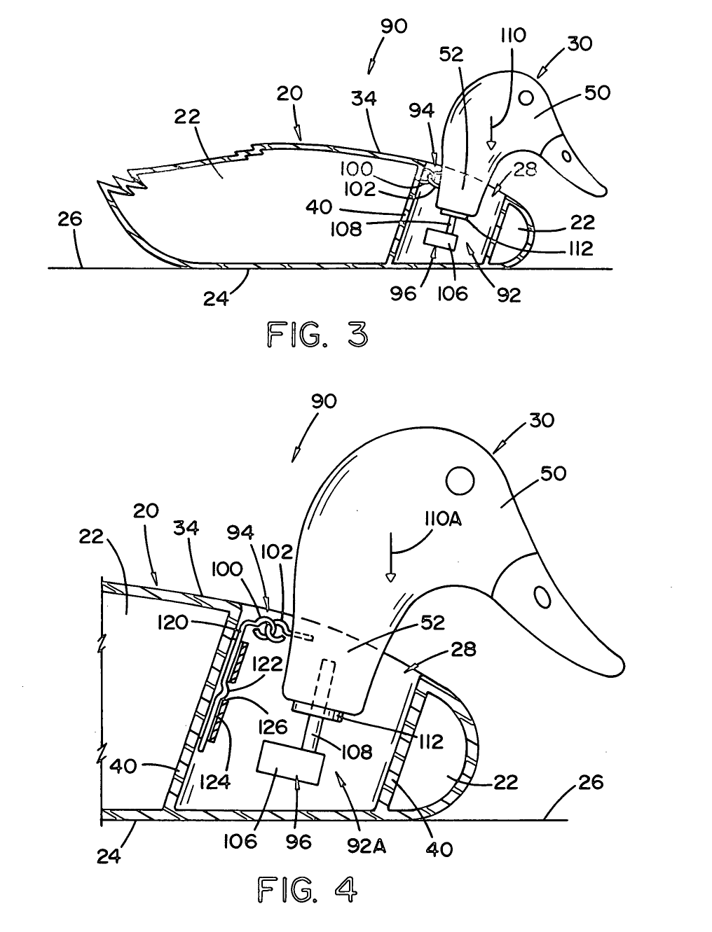

Referring to FIG. 2, shown is decoy 70 having a decoy body 20 and a head assembly 30 with a similar pivoting assembly 32. However, decoy 70 includes a shortened cavity 72 having a bottom 74 spaced from body bottom 24. As a result, cavity walls 76 are shorter than those discussed above, and pivoting assembly 32 can include a shortened flexible member 78. As can be appreciated, spacing the cavity bottom from the body bottom can be used to adjust the pivot point of the head assembly. However, as will be discussed in greater detail below, other methods can be used to change the pivot point of the head assembly without detracting from the invention of this application.

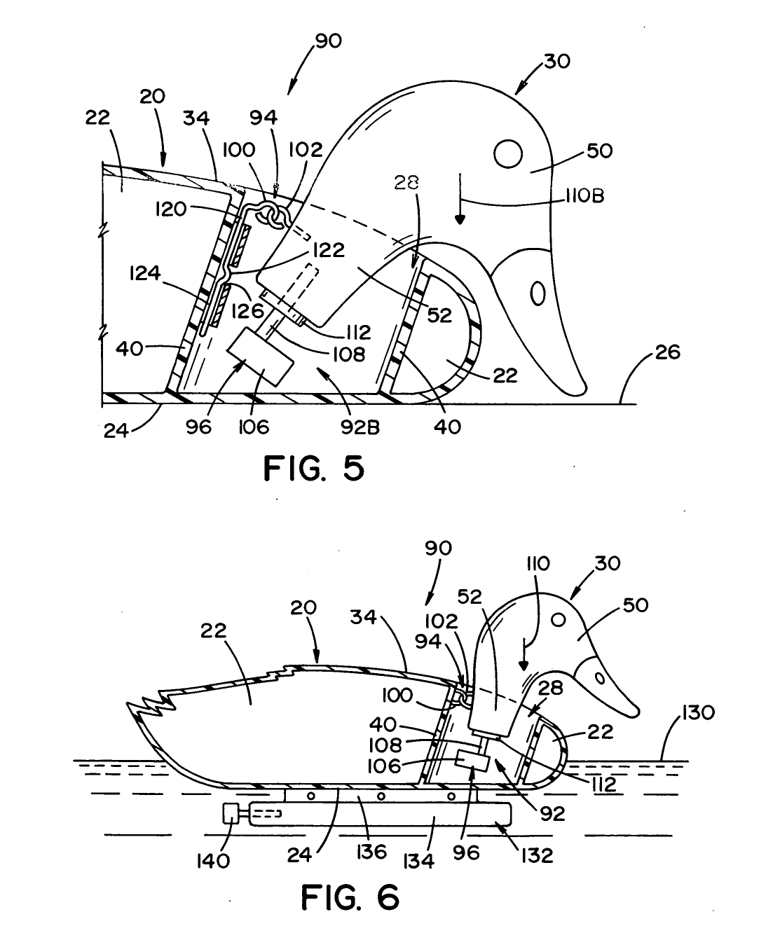

Referring to FIG. 3, shown is decoy 90 having a decoy body 20 and a head assembly 30 including a pivoting assembly 92. More particularly, pivot assembly 92 includes a pivoting or articulating connector 94 and a weighted arm 96 that work together to produce a desire motion. Pivoting connector 94 includes a loop 100 connected to body 20 and a loop 102 connected to head assembly 30. While loops are shown, any known pivoting connector can be used without detracting from the invention of this application. Further, as can be appreciated, the connector, as will be discussed in greater detail below, can also be designed to allow the head assembly to be removed from the body. Pivoting assembly 92 includes a weight 106 and an arm 108 that space weight 106 sufficiently from pivot 94 to produce the desired home position of the head assembly. As can be appreciated, based on the spacing between joint 94 and weight 106, a center of downward force 110 is produced, which controls the home position of the head assembly. However, wind and movement of water can easily cause motion in the head assembly. Decoy 90 can further include a mount 112 on head assembly 30 to better secure connect arm 108 thereto.

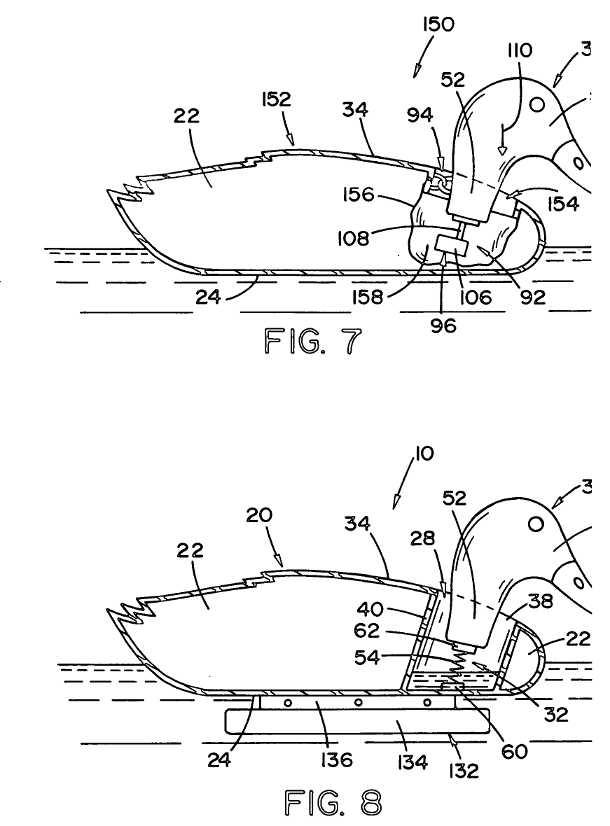

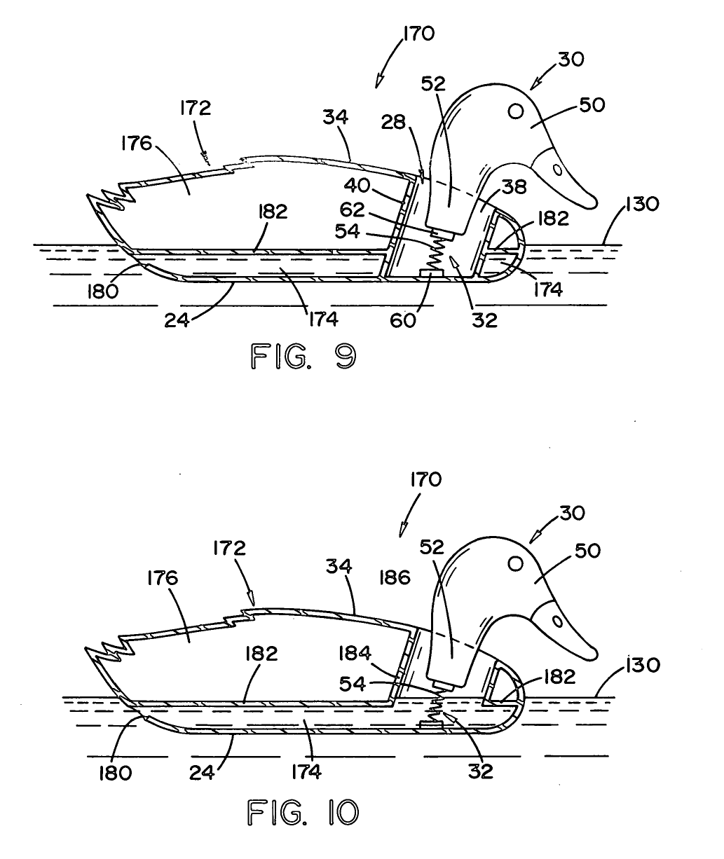

Pivoting assembly 92 can also be adjustable. In this respect, weight 106 can move relative to arm 108, and/or arm 108 can move relative to head assembly 30 to change downward force center 110 of the assembly. With special reference to FIGS. 4 and 5, shown is pivoting assembly 92 in a first position 92A and a second position 92B, respectively. The change in position between 92A and 92B, is a result of the rotation of weight 106 relative to arm 108, along with the off-center connection between the weight and the arm. As a result, weight center 110B is forward of weight center 110A, thereby causing the home position of head assembly 30 to rotate forwardly about joint 94. As can be appreciated, 92A and 92B represent only two adjustment points, and pivot assembly 92 can also be only partially rotated to produce less significant variations in the home position.

As is discussed above, decoy 90, as with other embodiments of the present invention, can include a removable head assembly so that different head configurations or designs can be used with the same decoy body, and/or the decoy can be stored more efficiently, as will be discussed in greater detail below. In this respect, ring 100 and/or ring 102 can be a hook or other detachable configuration and or can include any one of a number of clasps known in the art. As is also shown in FIGS. 4 and 5, joint 94 can include a hook 100 that is connected to a downward leg 120, such that hook 100 and leg 120 are L-shaped. Further, hook 100 and leg 120 can be made from a wire. Further, leg 120 can have a detent 122, such that leg 120 is frictionally receivable in a channel 124. More particularly, channel 124 can have an opening or recess 126 shaped and/or sized to receive detent 122, wherein, as leg 120 is pushed into channel 124, detent 122 enters opening 126 and frictionally locks hook 100 relative to body 20. Further, leg 120 and hook 100 can be removed from channel 124 by deforming detent 122. Again, while one particular configuration of a removable assembly is shown, any known mechanism in the art can be used for joint 94 to allow the head assembly to be selectively removed.

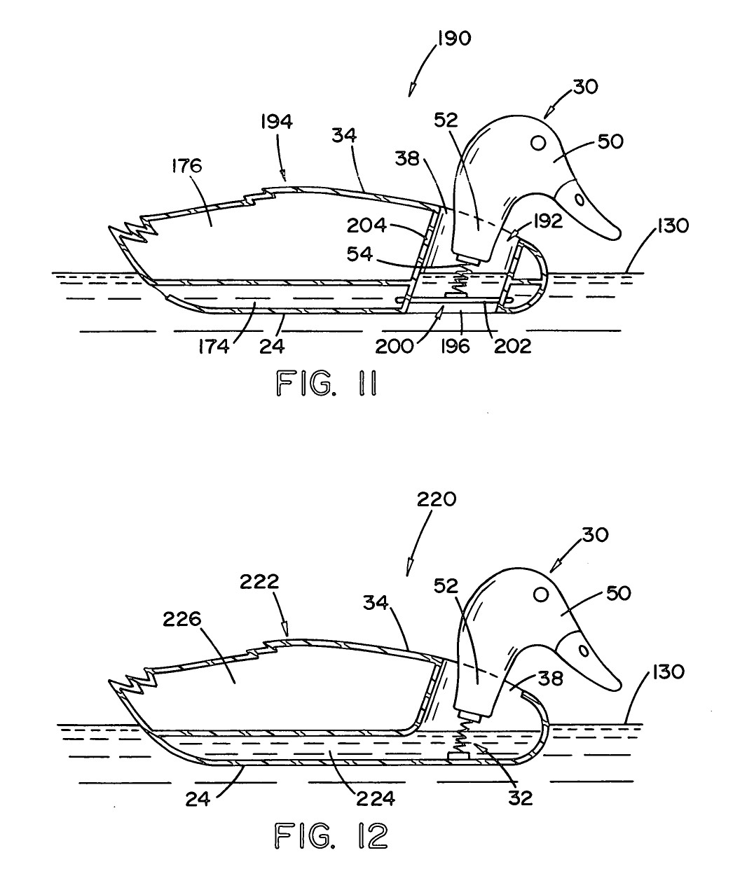

As is discussed above, the decoys of this application can also be used in water. In this respect, as is shown in FIG. 6, decoy 90 can be positioned in water 130. In order to make the decoy more stable in water, decoy 90 can include a keel 132, which can be a weighted keel. Other weighting systems known in the art are water chambers, which will be discussed below. These systems can be used to make sure decoy 90 maintains a more upright position. Keel 132 can also be a weighted keel, in that a keel base 134 is filled with a heavy material such as sand. Keel 132 is joined to decoy body 20 by a vertical strip 136 and can be joined to the body using any method known in the art. Further, as is also known in the art, keel 132 can also be detachable, so that decoy 90 can be used for both land applications and water applications. Further, while not shown, the decoy of this application can be configured to be used with a separate mounting apparatus, such as a mounting stake, for even further versatility. In order to better balance the decoy for use in water, and/or to compensate for weight 106 of pivot assembly 92, keel 132 can also include a weight 140 that can be adjustable. In this embodiment, weight 140 is positioned on the rear of keel 132 and is sized to account for weight 106.

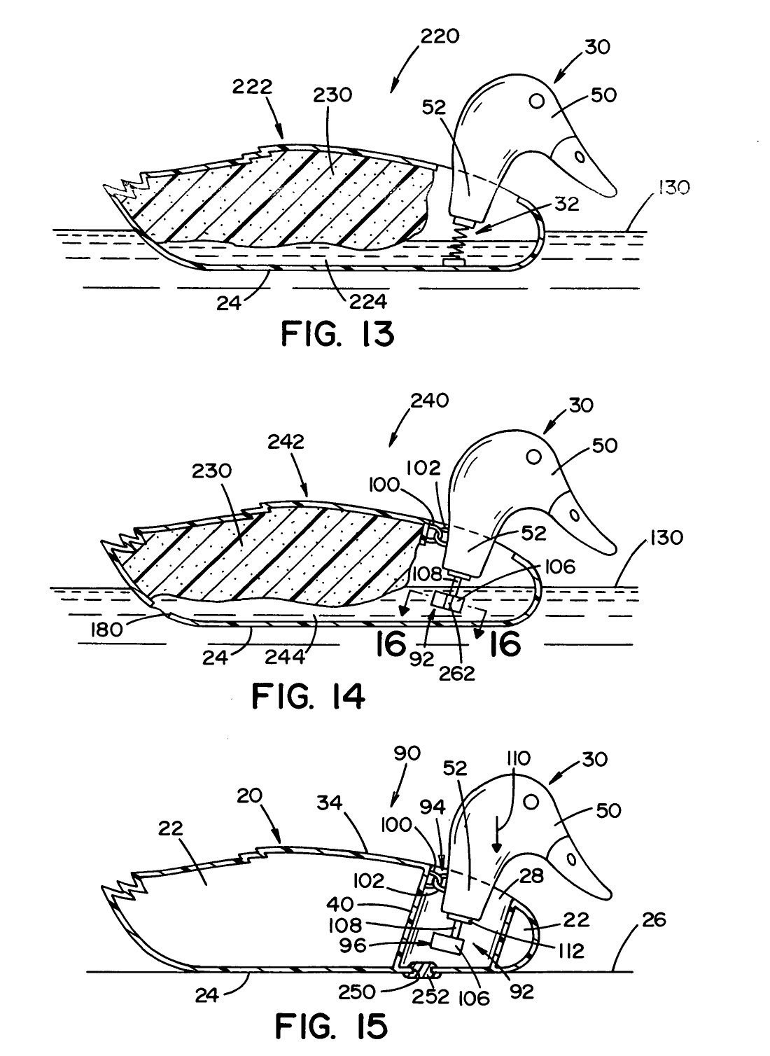

With reference to FIG. 7, and as is also discussed above, the body cavity can be reconfigured without detracting from the invention of this application. More particularly, decoy 150 includes a decoy body 152 having an opening 154 in upper surface 34 of the decoy. Body 152 further includes a bag 156 that produces a bag cavity 158 which is not dimensionally rigid. This configuration can produce a wider range of motion in head assembly 30, in that pivot assembly 92 is virtually unobstructed by any side walls. Nonetheless, the use of a bag prevents water from entering buoyancy chamber 22, which allows the decoy to remain buoyant in the water.

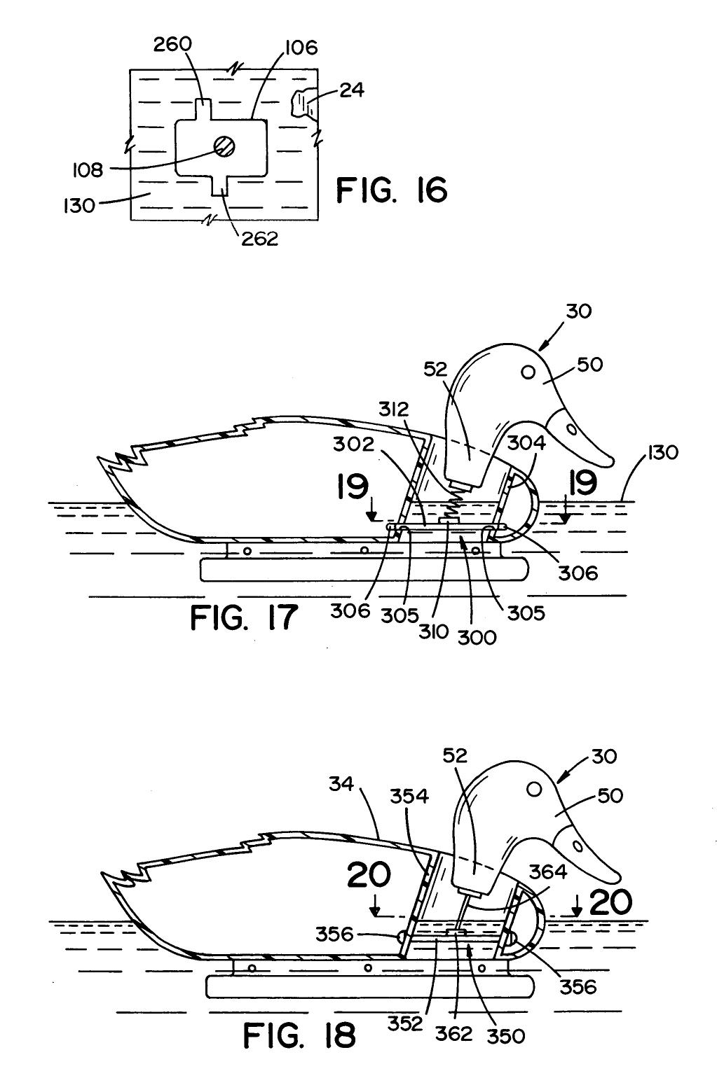

With reference to FIG. 8, and as is also discussed above, the decoys of this application can be used for both land applications and water applications. Further, different components can be used interchangeably with different embodiments of this application, even though not shown with the particular embodiment. For example, decoy 10 can be used for water applications and can include keel 132.

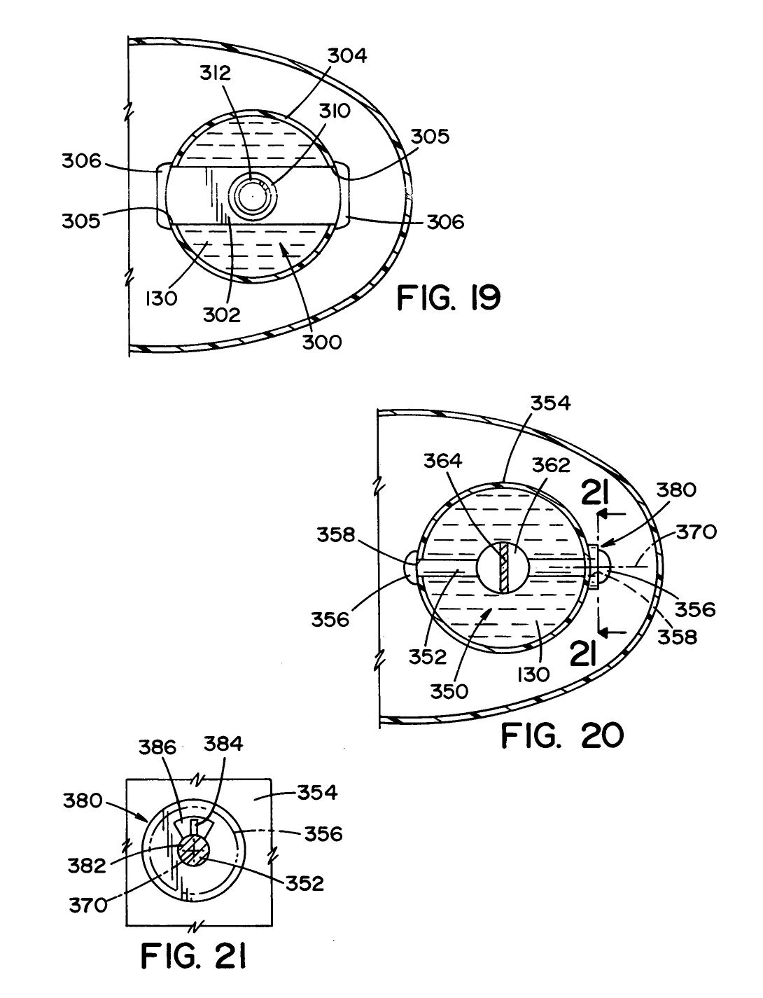

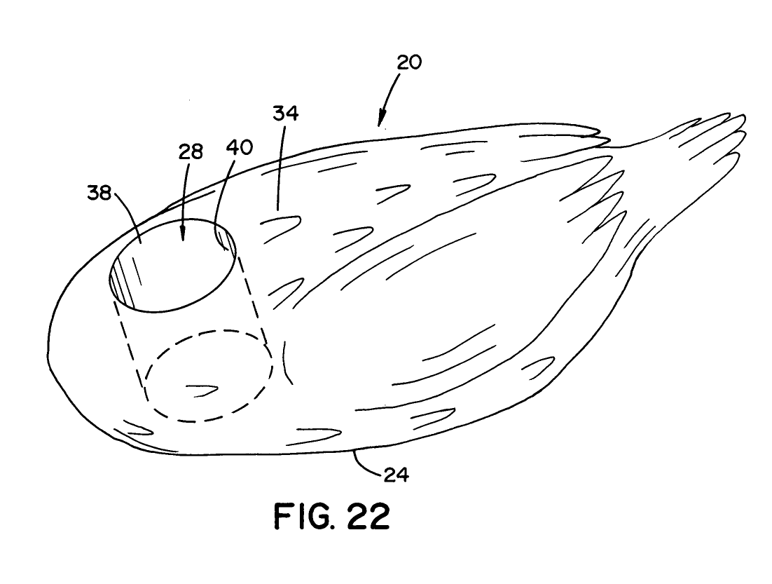

With reference to FIGS. 9-13, decoys according to the present invention can include differing types of water chambers and/or buoyancy chambers that can be used to help stabilize the decoy in water applications, simplify design and/or manufacturing, and/or allow for more efficient storage of the decoy, and can be used for further reasons and/or benefits. In this respect, decoy 170 is shown to include a body 172 having a flow-through water chamber 174 and an air chamber 176 for a buoyancy chamber. Water is allowed to freely enter water chamber 174 by way of an opening 180 in the water chamber. Internal wall 182 can be used to separate the water from the air chamber to maintain a desired buoyancy of the decoy. As can be appreciated, the size of the water and air chambers is a function of a desired floating position of the decoy and can be altered without deviating from the invention of this application. Further, as is shown, water chamber 174 can be separated from cavity chamber 28 by a continuation of wall 40 to bottom 24. As can be appreciated, water chamber 174 can be used to eliminate the need for keel 132. Further, as is shown in FIG. 10, the decoy can include a shortened cavity wall 184, such that the water can freely flow through cavity 186.

With reference to FIG. 11, decoy 190 is shown, which includes a flow-through cavity 192. In this respect, decoy 190 has a decoy body 194 having both a top opening 38 and a bottom opening 196, wherein water is free to flow through the cavity. Decoy body 194 can further include water chamber 174 that can be open to cavity 192 or can include a separate opening (not shown). Pivot mechanism 200 can be connected to the body by a cross member 202, if the spring configuration is used, or can be jointed directly to the wall, for example, if the weighted configuration is used. The cross member can be joined to the body and/or a cavity wall 204 by any known method in the art.

With reference to FIG. 12, decoy 220 is shown, which includes a decoy body 222 having a semi-dry chamber 224 and an air buoyancy chamber 226. While water is capable of entering chamber 224, there is no hole in the bottom portion of body 222 to allow the free flow of water into this chamber. As stated above, with respect to other embodiments of this application, keel 132 can also be used for this embodiment. As can be appreciated, based on the wind and other factors, water can be flat or can be choppy. As a result, water can enter through opening 38 into the decoy body for all embodiments. This water influences the buoyancy of the decoy and if the entering water is concentrated in one location, it can cause the decoy to tilt toward the position of the trapped water. By including a large semi-dry chamber, that water can be better dispersed naturally and will produce less tilting of the decoy.

As can also be appreciated, molding individual chambers can increase the complexity of the molds and/or manufacturing techniques. As a result, and as is shown in FIG. 13, the air or dry chambers of the embodiments of this invention can be molded into the decoy body, or they can be a separate component. For example, decoy 220 can include a buoyant foam insert 230 that can be molded into body 222 or can be applied after body 222 is molded such as, but not limited to, by spraying an expandable foam into the body after the body is molded. Further, chamber 226 can be an inflatable chamber that is attached to or positioned within the body after molding and which can be used in connection with other manufacturing techniques to create a collapsible decoy. It should also be noted that the decoy can have an open bottom when a buoyancy chamber is used.

With reference to FIGS. 14-16, shown are decoys which utilize a flow through or flooded chamber to produce a stabilizing effect on pivoting mechanism 92 and, thus, on the movement of the head assembly. This can be used to reduce the movement of the head assembly in windy conditions or the like. In this respect, FIG. 14 shows a decoy 240 having decoy body 242 with an open chamber 242. The same opening 180 can be used to allow the inflow of water 130. Further, foam 230 can be used to maintain buoyancy. By flooding the chamber, the weighted portion can be at least partially submersed in water and is subjected to moving resistance by the water, which will have a damping effect. However, as can be appreciated, the configuration shown in FIG. 14 can only be used with other flooded cavities. In yet another embodiment, the cavity can be selectively floodable. In this respect, FIG. 15 shows decoy 90 which further includes a bottom opening 250 that is selectively closeable by a plug 252. Therefore, the chamber can be flooded when desired or can be maintained substantially dry, based on the weather and/or other conditions. Further, based on the desired damping effect (FIG. 16), weight 106 can include fins 260 and 262 to further dampen the motion of the head assembly.

With reference to FIGS. 17-21, shown are decoys which utilize yet another support structure for the pivoting mechanism for the head assembly. While these embodiments show a flooded cavity, they can be utilized with a dry or semi-dry cavity sealed bottom or even partially opened bottoms or substantially opened bottom decoys and, therefore, the discussion will be limited to the pivoting mechanism. As can be appreciated, a rigid cavity design can be used with a flexible body to allow the decoy to collapse. This can include, but is not limited to, inflatable decoys with a rigid cup configuration.

FIGS. 17 and 19 show a pivot mechanism 300 having a base arm 302 connected on both ends to chamber wall 304 by any known fastening mechanism, and the arm can even be molded into the chamber. Further, arm 302 can also be secured to chamber wall 304 at one point. For example, arm 302 can have self-locking mechanisms 306 molded into one or both ends, and wall 304 can include openings 305 shaped to receive the locking mechanisms such, that they can be pushed into but cannot be pulled out. Mechanism 300 can further include a spring base 310 mounted to arm 302 and shaped to receive the base of a flexible member 312. The top of the flexible member 312 is joined to head assembly 30. As with other embodiments, the head assembly can be designed to be selectively received by the flexible member to allow removal thereof for storage and/or the use of different head configurations. Further, the flexible member in the embodiments can be selectively replaceable to allow different motions to be used, based on the desired motion of the head and the weather condition. As discussed above, during more severe weather conditions, motion of the head may need to be restricted, which can include a damping mechanism extending about the flexible member, such as a polymer sleeve (not shown) and/or compressible inserts that can be positioned in the cavity (also not shown). By utilizing arm 302, the base of the cavity is not needed (flooded chamber), and/or the base of the chamber does not need to be structurally sound, such as with an inflatable or other collapsible decoys. Further, openings 305 can be elongated openings to allow the base of the assembly to be moved up or down to allow use of differing flexible members and/or head assemblies to create different motions and/or appearances.

With reference to FIGS. 18, 20 and 21, shown is pivot mechanism 350, including a bar support 352 that is joined at either end to chamber wall 354. As with the embodiments discussed above, support 352 can be joined by any mechanism known in the art, including self-locking tabs 356 that lock in openings 358 in wall 354. Mechanism 350 further includes a flexible member mount 362 connected to bar 352, which connects, at least selectively, a strip-like flexible member 364 to bar 352. Flexible member 312 is connected to head assembly 30 at its opposite end. In this configuration, the head assembly is restricted to rocking motion in a vertical plane coplanar to the page about a horizontal axis extending out from the page. However, the positioning of this axis is below surface 34 of the decoy body, thereby creating a realistic head motion. In order to create motion in multiple planes, bar 352 can at least have ends which include a portion that allows the bar to at least partially rotate about an axis 370. This can be used to create additional motion; Further, pivot mechanism 350, which is also below surface 34, can include a rotation limiter and/or centering device 380. More particularly, bar 352 can include a locking portion 382 having a radially extending tab 384. Wall 354 can include a lock aperture 386, which can be formed in wall 354 and/or a separate component fixed to wall 354. The tab of bar 352 extends into aperture 386, wherein the wall of the aperture limits the rotation of the bar about axis 370. Further, a biasing spring (not shown) can also be used to center the mechanism as is desired by the user.

As with all embodiments, the flexible member can be any known flexible member including, but not limited to, a coil spring, a flat sheet spring or an elongated piece made from a flexible polymer.

While considerable emphasis has been placed on the preferred embodiment of the invention illustrated and described herein, it will be appreciated that other embodiments can be made and that many changes can be made in the preferred embodiment without departing from the principles of the invention. Accordingly, it is to be distinctly understood that the foregoing descriptive matter is to be interpreted merely as illustrative of the invention and not as a limitation.

Having thus defined the invention, the following is claimed:

1. A decoy comprising an outer body that resembles a creature of nature and an appendage that moves relative to said outer body, said outer body defining the outer limits of an inner cavity and including at least one opening, said appendage being joined to said decoy at an appendage joint spaced from said outer body and within said inner cavity such that said appendage extends from said opening and moves relative to said outer body about a pivot point at least partially within said inner cavity.

2. The decoy of claim 1, wherein said appendage is a head.

3. The decoy of claim 1, further including a biasing member extending between said joint and said appendage.

4. The decoy of claim 3, wherein said biasing member includes a coil spring.

5. The decoy of claim 3, wherein said biasing member includes a flexible polymer.

6. The decoy of claim 3, wherein said biasing member includes a flexible rubber.

7. The decoy of claim 4, wherein said biasing member further includes a flexible sleeve extending about said coil spring.

8. The decoy of claim 1, further including an appendage cavity extending from said opening into said inner cavity, said appendage cavity including at least one side wall and a base, said joint being on said base.

9. The decoy of claim 8, wherein said base is spaced from said outer body.

10. The decoy of claim 8, wherein said base is formed from a portion of said outer body.

11. The decoy of claim 8, further including a biasing member extending between said joint and said appendage, said biasing member interconnecting with said appendage within said outer body such that said biasing member is fully contained within said appendage cavity.

12. The decoy of claim 8, wherein said opening is a generally upwardly facing opening and said appendage is a head.

13. The decoy of claim 1, further including an appendage cavity extending from said opening into said inner cavity, said appendage cavity including at least one side wall and a base, said joint being on said at least one side wall and spaced from said outer body.

14. The decoy of claim 13, wherein said joint is an articulation joint, said appendage further including a weighted member below said articulation joint.

15. The decoy of claim 14, wherein said weighted member is joined to a base of said appendage and said weighted member is adjustable relative to said appendage.

16. The decoy of claim 14, wherein said articulation joint is selectively connectable to said side wall such that said appendage is selectively detachable.

17. The decoy of claim 1, further including an appendage cavity extending from said opening into said inner cavity, said cavity including a means for maintaining water in said appendage cavity, said appendage further including a downwardly extending biasing member configured to extend into said water and bias the movement of said head relative to said body.

18. The decoy of claim 17, wherein said opening is a first opening, said means for maintaining water including a second opening in said outer body that allows water to partially fill said appendage cavity.

19. The decoy of claim 17, wherein said decoy further includes a sealed flotation chamber in said inner cavity.

20. The decoy of claim 19, wherein said sealed flotation chamber includes a sealable flexible bag.
